(19) United States
(12) Patent Application Publication
(10) Pub. No.: US 2025/0104017 A1
(43) Pub. Date: Mar. 27, 2025

(54) GENERATIVE CUSTOMER EXPERIENCE AUTOMATION

(71) Applicant: Ushur, Inc., Santa Clara, CA (US)

(72) Inventors: Henry Thomas Peter, Mountain House, CA (US); Vijayendra Mysore Shamanna, Cupertino, CA (US); Simha Sadasiva, San Jose, CA (US); Kashif Mahbub, San Jose, CA (US); Mayank Choubey, San Jose, CA (US); Ravil Kashyap, Bengaluru (IN)

(21) Appl. No.: 18/889,015

(22) Filed: Sep. 18, 2024

Related U.S. Application Data
(60) Provisional application No. 63/584,315, filed on Sep. 21, 2023.

(51) Int. Cl. G06Q 10/10; G06Q 30/015

(52) U.S. Cl. CPC G06Q 10/103; G06Q 30/015

(57) ABSTRACT

This disclosure describes visual interfaces as well as underlying methods and systems for bringing generative customer experience automation to the enterprises and their end-users. A visual workflow builder is part of a micro-engagement system that allows for creation of workflows without writing any code. The micro-engagement platform is enhanced to support an environment where the content of the micro-engagement can be generated, presented and selected by an enterprise persona and launched to the end-users. The generated content is more dialog-friendly and is based on a set of parameters around specific workflows and prior practices as learned by Large Language Models or other relatively smaller but more domain-specific fine-tuned language models. End-users can also input their descriptions through which apt workflows can be dynamically generated at runtime, thereby personalizing the end-user's engagement experience further.

### RELATED APPLICATIONS

This application is related to and claims the benefit of U.S. Provisional Patent Application No. 63/584,315, filed Sep. 21, 2023, titled “Generative Customer Experience Automation,” the entirety of which is incorporated herein by reference.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

The present disclosure generally relates to customer engagement automation, and specifically to the area of enhancing customer experiences using generative artificial intelligence.

### BACKGROUND

The Applicant of the current patent application disclosed a micro-engagement platform in an earlier patent application, titled, “System and Methods for a Micro-Engagement Platform,” which issued on Mar. 1, 2022 as U.S. Pat. No. 11,263,666. The micro-engagement platform transmits a snippet of information to an end-user's device (that can be a mobile device or a desktop) that can be viewed and responded to quickly. Upon completion of one micro-engagement by the end-user, the platform serves the next micro-engagement and eventually serves a sequence of micro-engagements, thereby achieving the overall goal of user engagement and establishing enterprise workflows. Micro-engagement platform gives the end-user flexibility in mode of engagement rather than getting them stuck with a committed mode of engagement, such as Interactive Voice Response (IVR) or desktop web chat. In short, micro-engagement platform is a mechanism that is designed to bring compelling end-user experiences with the primary objective of bringing in end-user conversions and closures in getting responses and information from the end-users for an enterprise who provides services or goods to the end-user. Note that the end-user is the ultimate consumer of the service or good.

With the rise of the Large Language Models (LLM) and the generative capability of an AI-powered platform, the existing micro-engagement capabilities can be enhanced in a consumer-friendly way, if an appropriate set of questions are asked, adequate responses are provided to advance interaction, and/or proper interfaces are provided to the end-user to express their needs. End-user's interest in providing information depends a lot on the enterprise persona with whom the end-user is engaging. Therefore, the enterprise persona needs to be empowered with tools to generate fitting engagement texts.

### SUMMARY

The following is a simplified summary of the disclosure in order to provide a basic understanding of some aspects of the disclosure. This summary is not an extensive overview of the disclosure. It is intended to neither identify critical elements of the disclosure, nor delineate any scope of the particular implementations of the disclosure or any scope of the claims. Its sole purpose is to present some concepts of the disclosure in a simplified form as a prelude to the more detailed description that is presented later.

This disclosure presents visual interfaces as well as underlying methods and systems for bringing generative automated customer experiences to the enterprises and their end-users. Note that the word “customer” encompasses various entities. A business enterprise can be a customer for another business entity that provides a customer experience automation (CXA) platform. The Applicant of this patent application, Ushur, Inc. is one such entity that provides the CXA platform described herein. On the other hand, the business enterprise, who is the customer of the platform provider, has the end-users (or consumers) as their customers.

At the core of the CXA platform is a patented micro-engagement system. A visual workflow builder is part of the micro-engagement system that allows for creation of workflows without writing any code. The existing version of the generic micro-engagement platform is enhanced in this patent application to support an environment where the content of the micro-engagement can be generated, presented and selected by an enterprise persona and launched to the end-users. The generated content is more dialog-friendly and is based on a set of parameters around specific workflows and prior practices brought about by Large Language Models or other relatively smaller but more domain-specific fine-tuned language models. End-users can also input their descriptions through which apt workflows can be dynamically generated at runtime, thereby personalizing the end-user's engagement experience further. This revolutionary capability enhances enterprise's services by offering a new service that the enterprise persona could not expect to be required at the workflow creation time, as the end-user's intent was not fully knows during workflow creation time.

In one aspect, the present disclosure involves providing a novel set of high-level visual interfaces to an enterprise persona with an ultimate goal of empowering the end-users to create and/or propagate automated workflows. The high-level interfaces given to the enterprise persona enables the persona to generate an effective engagement text (that can be converted into other mediums such as voice, if required) to their end-users with a mere description or a mere selection of a preference. This way the enterprise persona can initiate an entire workflow that can be launched. The enterprise persona is given options to explicitly give tools for end-users to be able to customize workflow, while the underlying system remains open and the global generative capability is allowed for end-users.

In a key aspect, the present disclosure permits the enterprise to present a playground of all necessary ingredients including data and hooks for their consumers (end-users). The end-users, through a mere description of what they need, are enabled to internally generate workflows and enhance a more personalized experience for themselves. In short, this disclosure permits a micro-engagement platform to enhance customer service experience by leveraging the end-user's intent to create intelligent workflows at runtime within an enterprise. These are workflows that have not been provided by the enterprise; rather these workflows are created from the end-user's preference at the runtime, thereby taking the personalization of the micro-engagement platform to a new level.

The enhanced micro-engagement platform gets more suggestive and creative in understanding end-users' inputs and taking appropriate actions, such as intelligently responding to the end-user, validating end-user's response, and/or generating a completely new service at the runtime.

Specifically, a method for integrating workflows dynamically generated by an end-user during an automated interactive engagement session between the end-user and an enterprise is described. The method comprises: providing, by an enterprise persona, using a micro-engagement engine, a visual interface for the end-user to access and interact with a plurality of pre-created workflow modules, each of the plurality of pre-created workflow modules corresponding to a respective service that the enterprise is currently capable of providing to the end-user; collecting the end-user's input during runtime of a selected pre-created workflow module that the end-user is currently interacting with; analyzing the end-user's input at a backend of the micro-engagement engine to determine the end-user's expressed intent; and, responsive to determining, that the end-user's expressed intent is not covered by any of the plurality of pre-created workflows, generating a new workflow corresponding to a new service that is associated with the end-user's expressed intent.

### BRIEF DESCRIPTION OF THE DRAWINGS

The present disclosure will be understood more fully from the detailed description given below and from the accompanying drawings of various embodiments of the disclosure.

FIG. 1 illustrates a generic Customer Experience Automation (CXA) reference architecture using a micro-engagement platform, according to an embodiment of the present disclosure.

FIG. 2 illustrates a layered architecture using the micro-engagement engine that is incorporated into a generative CXA platform, according to an embodiment of the present disclosure.

FIG. 3 illustrates an example of decision-making by an enterprise persona to approve or reject a dynamically generated workflow, according to an embodiment of the present disclosure.

FIG. 4 illustrates a block diagram of scheduling mechanism for a workflow, according to an embodiment of the present disclosure.

FIG. 5 illustrates the architecture for industry-specific and task-specific fine-tuning of Large Language Models (LLMs), according to an embodiment of the present disclosure.

FIG. 6 illustrates the process of workflow generation, according to an embodiment of the present disclosure.

FIG. 7 is a flow diagram of an example method for integrating workflows dynamically generated by an end-user during an automated interactive engagement session between the end-user and an enterprise, in accordance with some embodiments of the present disclosure.

FIG. 8 illustrates an example machine of a computer system within which a set of instructions, for causing the machine to perform any one or more of the methodologies discussed herein, can be executed.

### DETAILED DESCRIPTION

Embodiments of the present disclosure are directed to empowering both enterprise persona and their end-users to create and propagate workflows within the enterprise automatically using artificial intelligence. The disclosed systems and methods not only allows for creation and deployment of consumer (end-user) experiences via automation but also enables the consumer experience to be created dynamically (at runtime) by both the enterprise (virtual or real persons) and the end-users themselves within the created walled-garden/playground of the enterprise.

Even the most advanced cutting-edge workflow automation systems are reliant only on the enterprise side to create a workflow. This disclosure truly shifts the paradigm by allowing the end-users to participate meaningfully in workflow automation within the enterprise, that too without having to code. This dramatic paradigm shift enables end-users to receive a truly personalized service from the enterprise, and the paradigm shift is made possible by Generative Artificial Intelligence (Generative AI). Before describing the CXA platform enhanced by Generative AI, we discuss the current state-of-the-art generic Customer Experience Automation (CXA) platform without the generative aspect.

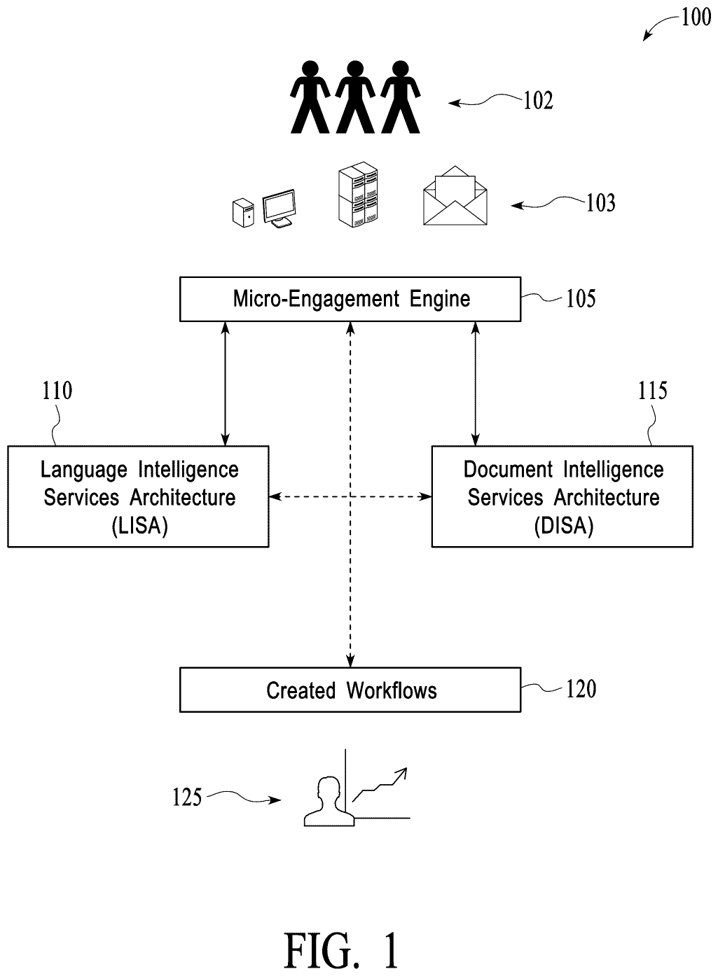

FIG. 1 illustrates a generic Customer Experience Automation (CXA) reference architecture 100 using a micro-engagement platform, according to an embodiment of the present disclosure. A micro-engagement engine 105 provides end-users 102 various modes of communication 105 (e.g., email, chat or link on a web browser on a desktop/laptop of mobile device or office server, text messages on mobile devices, voice calls etc.) to engage with an enterprise persona. The micro-engagement engine 105 relies on a Language Intelligence Service Architecture (LISA) 110 for natural language processing to extract relevant information from the end-user's textual input. The micro-engagement engine 105 may also rely on Document Intelligence Services Architecture (DISA) 115 for intelligent document processing to extract information from documents provided by the end-user or documents which the end-users filled out (such as a form). Workflows 120 can be created based on the automatically gleaned information from the end-user. An enterprise representative 125 (which can be a virtual person or a real person) is enabled to create workflows or act on the created workflow. In the generic architecture shown in FIG. 1, actual information provided by the end-user is used by an enterprise personnel to create workflows, but the end-user's intent is usually not fully utilized to generate workflows. The enterprise representative 125 engages through the CXA platform's goal builder (that requires no coding, hence called no-code builder). The information provided by the end-user goes to a data warehouse to get analyzed and summarized to figure out services that do not yet exist (missed services). These are the personalized services that the end-users need but have not yet been created by the enterprise persona.

As mentioned above, with Generative AI, the end-users themselves are empowered to create workflow dynamically, such that the workflow is even more aligned with the end-user's expressed intent. Generative AI is powered by very large machine learning models that are pre-trained on vast amounts of data, commonly referred to as foundation models (FMs). A subset of FMs, called large language models (LLMs), are trained on trillions of words across many natural-language tasks. The LLMs can be trained to emit customized content based on the input. The better the quality of the input, the better the generated content. The input instructions fed to a generative AI model are aptly called prompts. The art of crafting the most suitable prompt leads to prompt engineering. Prompt engineering is a rising important discipline that involves crafting the most suitable prompts to result in precise outputs.

This patent application describes novel systems and methods that can bring in this new paradigm of generating workflows automatically through a mere intent of a participant expressed in a description at a given visual interface, whether they are from the enterprise or from end-users served by the enterprise. The enterprise representative 125 engages through the CXA platform's no-code builder component to create workflows and/or act on generated workflows, as described below.

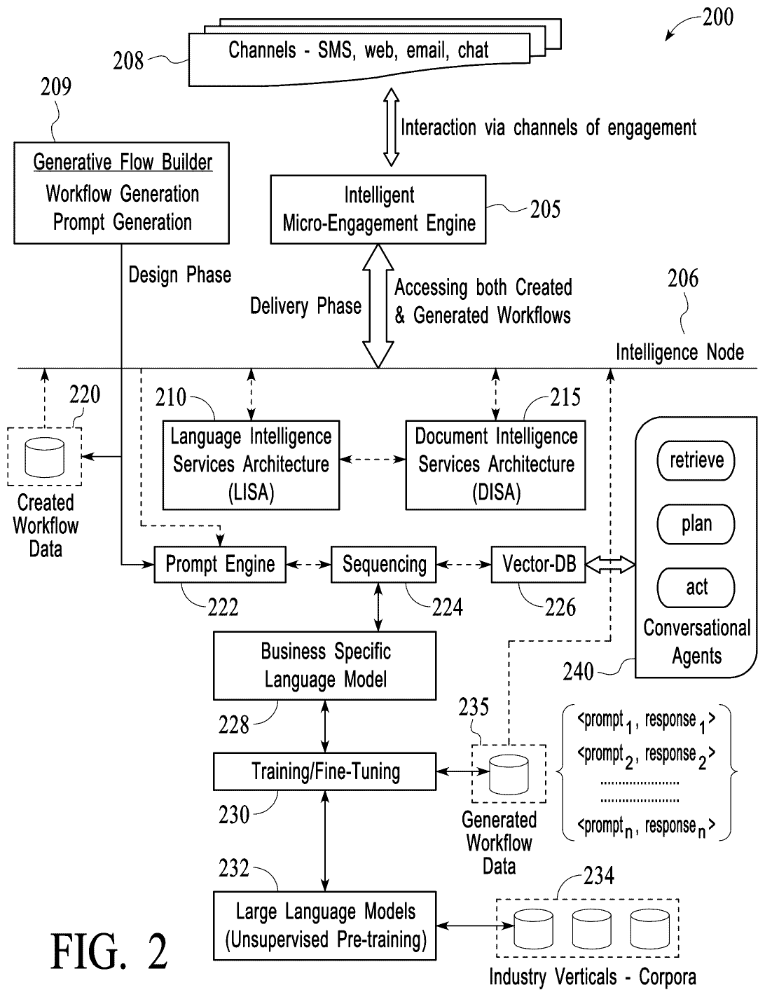

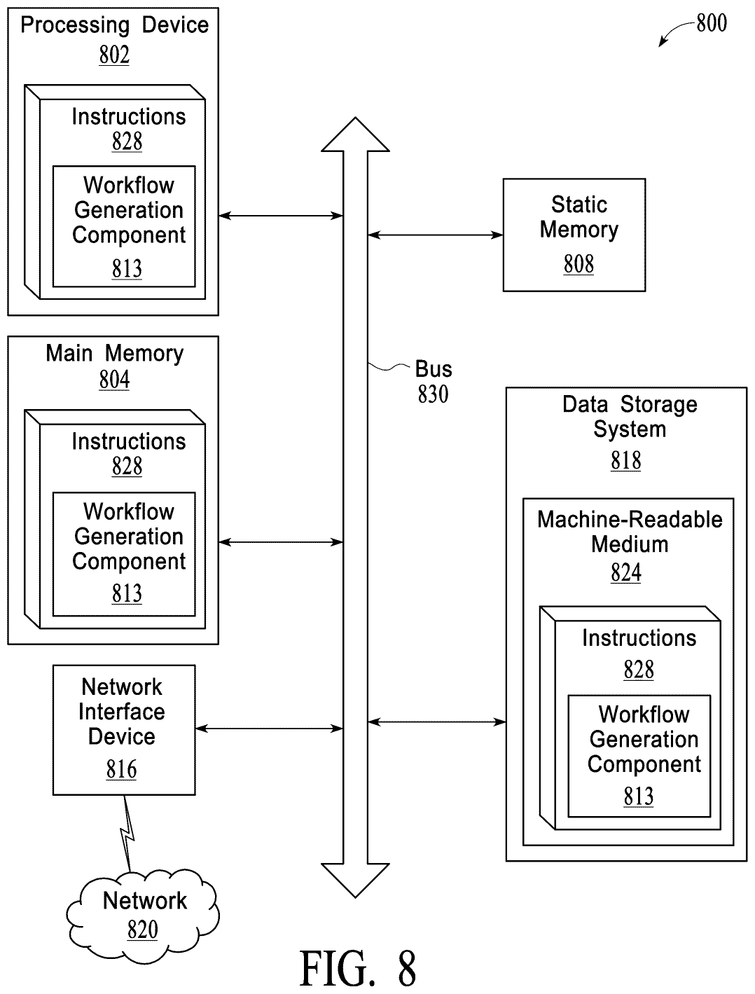

FIG. 2 illustrates a layered architecture 200 using the micro-engagement engine that is incorporated into a CXA platform which is enhanced with a ‘generative’ aspect to capture and capitalize the user's intent better for end-to-end intelligent automation purposes, according to an embodiment of the present disclosure. The architecture 200 is an improvement over the architecture 100 shown in FIG. 1, as architecture 200 leverages prompt engineering to automatically ‘generate’ workflows in addition to ‘creating’ workflows by the enterprise persona. The prompts created by the enterprise or the end-users can be weaved in related examples that match the descriptions and the system can arrange the prompt pipeline to instruct the LLMs to generate an apt workflow schema. In general, the various building blocks of the architecture 200 are part of a workflow generation component 813 in a computer system, as described further below with reference to FIG. 8.

The LLMs are capable of being taught via plain language on what to generate given the input description. The CXA platform (or any automation platform) can generate specific programming code (e.g., JSON elements) based on the input instructions. Examples of input and output JSON are illustrated further below in this patent application. The output JSON elements represent a simplified workflow specification that can be fed into the micro-engagement engine for execution.

In some embodiments, the instruction-tuned LLM can be created from foundational LLMs through supervised learning. One such example of supervised learning is a technique called Reinforcement Learning with Human Feedback (RLHF) where the model gets feedback from a human for each given instruction.

In the layered architecture 200 shown in FIG. 2, the intelligent micro-engagement engine 205 sits on top of an intelligence node 206 at the back-end to be able to deliver hyper-automation based on not only workflows that are created by enterprise persona, but also based on workflows that are ‘generated’ by using artificial intelligence (AI) and machine-learning (ML). The CXA platform provides a dynamic user interface at the front-end for serving a multi-persona dialog-based interaction between the end-user and one or more enterprise persona. In short, the Intelligent micro-engagement engine 205 can access both created workflow data 220 and generated workflow data 235 to enhance customer experience. The micro-engagement engine 205 engages with the end-users via various channels of engagement 208, such as text (e.g., SMS), web browser, email, chat etc.

The key tenet of the CXA platform is to leverage AI/ML throughout the CXA platform to elevate customer experience. Generative aspects of AI and LLMs are employed at multiple layers within the platform.

The first layer is in “Generative Flow Builder” 209. The generative flow builder 209 is one of the main building blocks of the workflow generation component 813. The generative flow builder acts during the design phase of the CXA platform to generate pre-created workflow modules. The generative flow builder 209 leverages generative models for prompt generation within a workflow and to generate the workflow itself. The generative flow builder 209 utilizes generative models, such as Large Language Models (LLMs) 232, for both prompt generation within a workflow and for the creation of the workflow itself.

Prompt Generation, in the context of Generative Flow Builder 209, refers to the capability of the builder interface to engage with the citizen developer (the individual who assembles various modules into a workflow using drag-and-drop functionality) in a multi-turn conversational format. This interaction allows for the customization of the output's tonality, verbosity, and style according to the specific requirements of the business use case, with the generative AI optimizing the module prompts accordingly. A citizen developer is a business user within the enterprise who creates software applications without extensive coding knowledge, usually using low-code or no-code tools.

Workflow Generation, in the context of Generative Flow Builder 209, involves a smart chat widget that interacts with the end-user or citizen developer in a multi-turn conversational manner to collect information, define guidelines, and determine the purpose of the workflow. The chat widget then automatically selects the appropriate modules and their attributes, integrates them, and produces a complete workflow ready for use by the end-user. This process is powered by Large Language Models and advanced prompt engineering techniques.

The second layer comprises the “Conversational Engine.” The conversational engine may be part of the Language Intelligence Service Architecture (LISA) 210. The conversational engine runs the conversational agents. Autonomous conversational agents 240 engage with end-users by various frameworks, such as ReAct (Reason and Act) or MRKL (Modular Reasoning Knowledge and Language) frameworks. These frameworks enable the conversational agents to retrieve information (e.g., from external APIs), and use natural language reasoning to plan and act on the retrieved information. This second layer coordinates with micro-engagement engine at one end and participates in multi-turn dialog with end-users to reach specified end-goals by enabling LLMs to perform certain actions.

The third layer has the Document Intelligence Services Architecture (DISA) for intelligent extraction of information from documents. Foundational LLMs 232 and/or fine-tuned domain-specific LLMs (228, 230) are leveraged for extracting relevant values for key business entities from unstructured documents and converting them into structured forms for downstream processing.

The second and third layers are employed during the delivery phase of the workflow automation, while, as mentioned above, the first layer of generative flow building is employed during design phase. The first layer of generative flow building is utilized by enterprise persona (e.g., 125), while the second and third layers are utilized by the end-users.

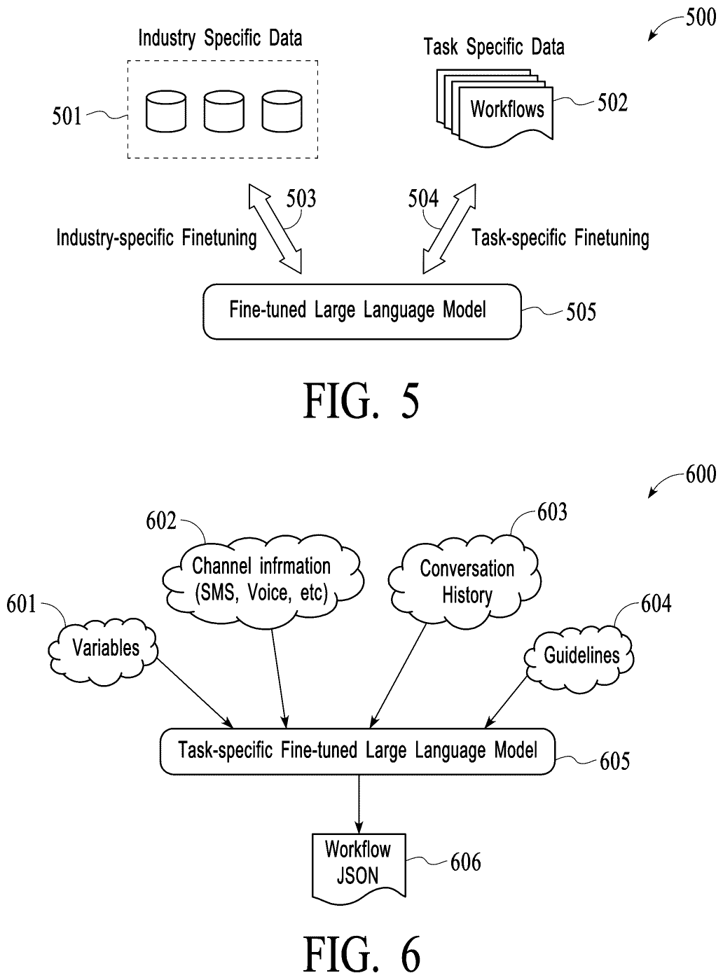

The efficacy of the Generative AI depends a lot on LLM training. One of the major goals in the present patent application is to tune a LLM to understand the end-user intent and to generate the right workflow JSON based on end-user intent. There are various ways of training the LLM with the required fine-tuning that is necessary. The workflow JSON contains a programmatic representation of the personalized service requested by and/or delivered to the end-user. FIG. 5 discusses aspects of fine-tuning in detail below.

One example is pretrained foundational LLM with few short customized JSON prompts—this is a quick way to run with in a deployment and can be packaged in a default offering on the cloud. The block 232 shows one such model. The foundational LLMs can be pre-trained by various corpora of data 234 relevant to industry verticals, such as insurance industry, healthcare industry etc.

Another example is pretrained LLM that is “instruction fine-tuned” with various workflow JSONs. The block 230 shows one such model.

A third example is a business enterprise's own LLM trained with domain-specific instruction workflow samples. Number of workflow generation samples may vary, and the number can be in the range of thousands or even more. The business-specific language model block 228 shows one such model, e.g., a language model for the Applicant Ushur, Inc.

The idea is to start with an unsupervised LLM and progressively tune it to become more and more domain-specific based on the enterprise's business need.

The supervised or semi-supervised training of an unsupervised pre-trained LLM determines the efficacy of the workflow ‘generation’. The candidate LLM prompts are first selected from a vector database 226 based on vector distance/similarity and infused further with context from the end-user description before feeding into the LLMs. Then the generated schema goes through a validity checker (not shown) which can attest to the schema's validity. The validated schema then goes through an integrity checker (not shown) that can attest to the error-free full workflow logic that the executing micro-engagement expects and further goes through a deployment checker (not shown) that can run through various checks to ensure that the workflow can be deployed safely. The generated workflow also goes through another visual adapter (not shown) layer that can convert the generated executable schema into a more exhaustive presentable schema that subsumes the execution schema parameters.

Once the run-time schema is generated and validated for deployment, the workflow can be scheduled for timely deployment or can be instantly deployed through the micro-engagement engine. The sequencing module 224 determines the scheduling. The prompt engine 222 is coupled to the generative flow builder 209 to enable the enterprise persona and/or the end-users to create effective prompts for creating and/or generating workflow (220, 235). The generated workflow data 235 is based on prompts and corresponding responses (e.g., the pairs indicated as <prompt₁, response₁>, <prompt₂, response₂>, . . . <promptₙ, responseₙ>).

While there are no properly established guidelines on the kind of prompts as this is still a nascent field, an explicit prompt that provides a clear and precise direction is needed. An example of a prompt can be: “Generate a workflow that can initiate a welcome with a greeting to the claim center and present a few options, such as, File a claim, Check status of a claim and Leave a feedback”. These options (e.g., “file a claim”, “check status”) are not themselves hooks, but behind each of these options, the system is trained to use one or more hooks to leverage when each of these options is generated. For example, a hook can be connection to a database. A specific configured webhook calls into enterprise systems. In other words, the underlying actions are the hooks and the system is already trained to leverage the correct underlying module that would use the hooks. Those specific modules are needed for a particular option (e.g., “file a claim.”).

As the system learns higher-level primitives, a context-based prompt can also be supported. An example for context-based prompt would be: “Would like to get some feedback from all claimants based on the last 3 months of claim submission and processing.” For a prompt like this, the system is capable of generating lookups on database which it had been previously trained on and other hooks it can generate to fulfill the specific requirements given in the prompt.

The system at the fundamental level supports prompts like that of code-generation where the prompt can be specific about each steps involved in the workflow that is going to be generated. As an example of a composite prompt consider this: “Please generate an usher that will first do the greeting, then post an open ended response to inquire on what the user is interested in and present services such as Filing a claim, checking the status of a claim as options, and allow the user to navigate among these options and when done with the existing services will be able to get some feedback on the overall experience of this engagement.”

In certain cases, based on user expression and input, multiple workflows may need to be generated. Some newly generated workflows may need to be associated with existing workflows. The multiple workflows may need to be sequenced in a certain order along with conditions. Consider an example like this from an end-user: “check my policy and if it is going to expire soon, send me a renewal link.” For this example, the system is capable of interpreting the end-user's intent properly. Only when the policy is going to expire with a certain predetermined time period to define ‘soon,’ the renewal flow would be generated or kicked-off if renewal has already been sent.

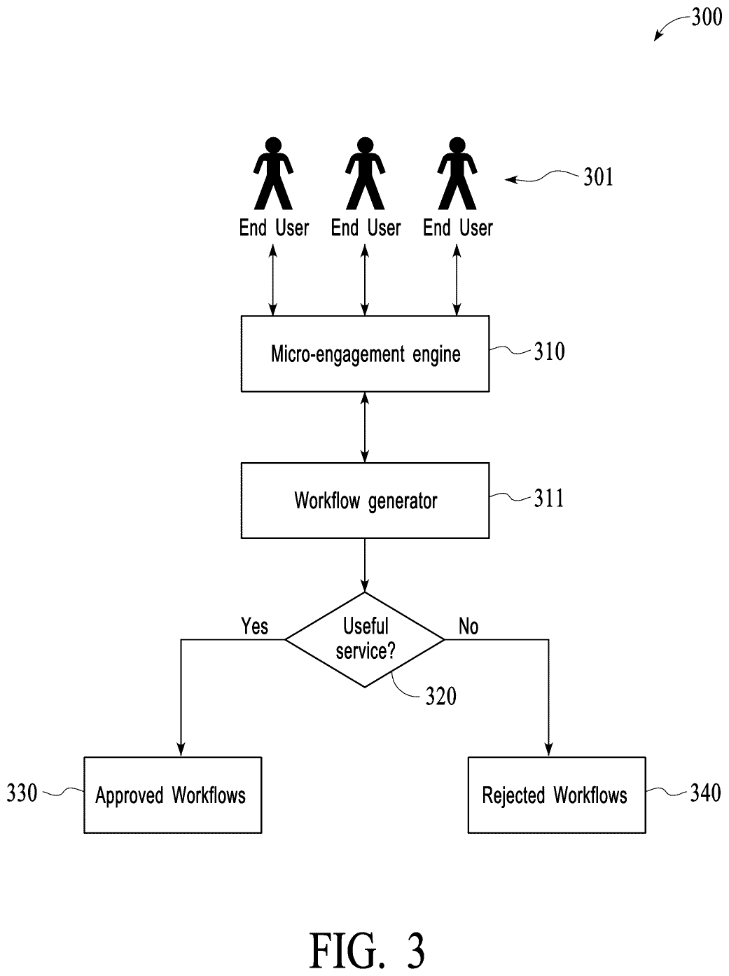

The enterprise persona sets boundaries (or guardrails) on the kind of services an end-user can generate. This ensures that the requested services are within the capabilities and domain of the enterprise. The enterprise persona has the capability to review the end-user generated workflows at a later point. It can decide to approve or reject some services that are outside the domain of the enterprise. FIG. 3 shows the lifecycle 300 of a dynamically generated workflow. The end-user 301 (similar to the end-users 102 in FIG. 1) working with micro-engagement engine 310 (similar to 205 shown in FIG. 2) through various channels (such as 208 in FIG. 2) has requested a service that is not yet provided by the enterprise as an already-created workflow. The micro-engagement engine 310 uses workflow generator 311 (similar to generative flow builder 209 in FIG. 2) to create JSON elements out of the end-user's textual input. An enterprise persona (virtual or a real person, such as 125 shown in FIG. 1) can review the generated workflows anytime and decides on approving them or rejecting them. If the generated workflow is deemed by the enterprise persona to be as an useful service at step 320, then the workflow is approved (330). The approved workflows are now part of the enterprise service and are available for the other end-users as well. If the generated workflow is deemed by the enterprise persona not to be as an useful service at step 320, then the workflow is rejected (340). The rejected workflows are services that don't fall in the capabilities or domain of the enterprise.

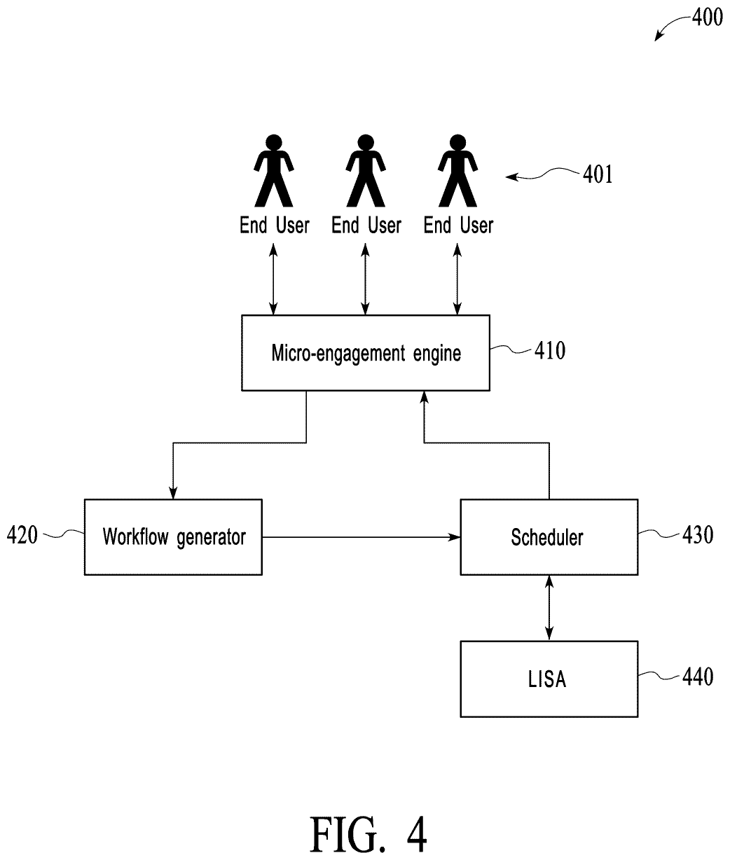

As shown in FIG. 2, the end-user's intent gets translated into simplified JSON elements that can either be immediately fed into the micro-engagement engine for execution or can be fed into a scheduler for future execution. FIG. 4 illustrates an example way to deploy an end-user generated workflow. The end-user 401 (similar to 102 or 301) works with enterprise provided service through the micro-engagement engine 410 (similar to 310). Based on the end-user's textual input, the workflow generator 420 (similar to 209 and 311) generates a dynamic workflow. The workflow generator 420 hands over the generated work to workflow scheduler 430. The workflow scheduler 430 utilizes the services of LISA 440 (similar to 210) to determine the appropriate scheduling of the generated workflow. The common scheduling options are immediate deployment or future deployment. The workflow scheduler 430 creates database records (e.g., in 235 in FIG. 2) to schedule the dynamic workflow at the appropriate time. Another aspect of generated workflow deployment is fine-tuning, as illustrated in FIG. 5. Fine-tuning involves a comprehensive two-stage process. Initially, the model is subjected to industry-specific fine-tuning, where it is trained on industry-specific data (501) to develop a base model that adapts to the industry's unique nuances and terminology (industry-specific fine-tuning, 503). This step ensures that the model is well-aligned with the general context and requirements of the target industry. Subsequently, the model undergoes task-specific fine-tuning (504), where it is further refined using task-specific data, such as workflow JSONs (502), to enhance its performance for specific tasks or applications. This approach allows the model to excel in performing particular functions or solving specific problems within the industry. By leveraging both industry-specific fine tuning (503) and task-specific fine-tuning (504) techniques, we build robust fine-tuned model 505 that not only understands the workflows and intricacies of the industry but also generate workflows with precise and contextually relevant steps that align with the user's service requests.

As depicted in FIG. 6, it is crucial to provide the right input to effectively train the large language model (LLM) on the formation and utilization of workflows. The task-specific fine-tuned LLM (605) relies on accurate and relevant input data to function optimally. This includes workflow variables (601), which outline the essential parameters and elements of the workflow; channel information (602), which provides context about the communication medium; previous conversation history (603), which ensures continuity and relevance in the interaction; and guidelines (604), which define the rules and standards to be followed. Channels can be short messaging system (SMS), voice call/message, email, chat, data call etc.

By correctly integrating and processing these inputs, the LLM performs a thorough analysis and generates a JSON representation of the newly created workflow (606). This JSON output captures the structured format of the workflow, incorporating the nuanced data and insights processed by the model. Providing the right inputs is essential to ensure that the resulting workflows are precise, contextually accurate, and aligned with the specific requirements outlined in the input data. This meticulous approach guarantees that the workflows generated are both effective and relevant to the user's needs.

Below are a few examples to illustrate the workflow description JSON that is generated for various user prompts.

For collecting user information, the generated workflow JSON can be like this:

```
{
  ″campaignName″: ″collectUserInfo″,
  ″activate″: false,
  ″modules″: [
    {
      ″id″: ″module-1″,
      ″type″: ″onbrowser″,
      ″name″: ″launchIapp″,
      ″next″: ″module-2″
    },
    {
      ″id″: ″module-2″,
      ″type″: ″form″,
      ″name″:″userInformation″,
      “next” : “module-3
      ″formInputs″: [
        {
          ″type″: ″openResponse″,
        ″name″: ″Name″,
          ″prompt″: ″Enter user name″,
          ″inputType″: ″text″,
          ″variable″: ″userName″ },
        {
          ″type″: ″openResponse″,
          ″name″: ″PhoneNumber″,
          ″prompt″: ″Enter phone number″,
          ″inputType″: ″phone″,
          ″variable″: ″userPhoneNumber″
        },
        {
          ″type″: ″openResponse″,
          ″name″: ″Address″,
          ″prompt″: ″Please provide your address”,
          ″inputType″: ″text″,
          ″variable″: ″userAddress″
        },
        {
          ″id″: ″module-3″,
          ″type″: ″notify″,
          ″name″: ″closing″,
      ″prompt″: ″It's always our pleasure to help. Thank You!″
      }
  ],
```

For user feedback about the insurance claims experience, the workflow JSON can be like this:

```
{
  “campaignName”: “collectClaimsFeedback”,
    “activate”: false,
  “modules”: [
    {
      “id”: “module-1”,
      “type”: “onbrowser”,
      “name”: “launchIapp”,
      “next”: “module-2”
    },
    {
      “id”: “module-2”,
      “type”: “choiceYesNo”,
      “name”: “intentConfirmation”,
      “prompt”: “Would you like to provide feedback about your claims experience?”,
      “next”: { “1”: “module-3”, “2”: “module-10” }
    },
    {
      “id”: “module-3”,
      “type”: “notify”,
      “name”: “intentAcknowledgement”,
      “prompt”: “Great! Please provide your feedback below.”,
      “next”: “module-4”
    },
    {
      “id”: “module-4”,
      “type”: “form”,
      “name”: “collectFeedback”,
      “formInputs”: [
        {
          “type”: “openResponse”,
          “name”: “Feedback”,
          “prompt”: “Please provide your feedback about your claims experience.”,
          “inputType”: “text”,
          “variable”: “userFeedback”
        }
      ],
      “next”: “module-5”
    },
    {
      “id”: “module-5”,
      “type”: “notify”,
      “name”: “feedbackReceived”,
      “prompt”: “Thank you for your feedback!”,
      “next”: “module-10”
    },
    {
      “id”: “module-10”,
      “type”: “notify”,
      “name”: “closing”,
      “prompt”: “Thank you for your time!”,
      “next”: null
    }
  ]
}
```

A prompt can explicitly provide an example workflow JSON and the LLM can leverage its knowledge base and language understanding to generate a response based on what it knows about a particular task. Subsequently, this intermediary representation facilitates the creation of distinct JSON files for both front-end and back-end purposes. The resulting output is then seamlessly integrated into the user interface as a novel generative workflow. In the following illustration, the <DESCRIPTION> placeholder in the following example can be dynamically replaced with the user-provided description during the automated workflow generation process. The following illustrates an input prompt that train the LLM: “Using the following JSON representation of workflow as reference, generate a workflow JSON to “<DESCRIPTION>”. In this example, the “<DESCRIPTION>” is resetting a password after adequate authentication information is collected.

```
{
  “campaignName”: “invisibleAppDemo”,
“logo”: “https://upload.wikimedia.org/wikipedia/commons/thumb/2/2a/Nice_Logo_2.svg/498px-
Nice_Logo_2.svg.png”,
  “activate”: false,
  “modules”: [
    {
      “id”: “module-1”,
      “type”: “onbrowser”,
      “name”: “launchIapp”,
      “next”: “module-2”
    },
    {
      “id”: “module-2”,
      “type”: “choiceYesNo”,
      “name”: “intentConfirmation”,
      “prompt”: “Are you asking to reset your password?”,
      “next”: { “1”: “module-3”, “2”: “module-10” }
    },
    {
      “id”: “module-3”,
      “type”: “notify”,
      “name”: “intentAcknowledgement”,
      “prompt”: “I can help you in setting a new password”,
      “next”: “module-4”
    },
    {
      “id”: “module-4”,
      “type”: “form”,
      “name”: “accountAuthentication”,
      “formInputs”: [
        {
          “type”: “openResponse”,
          “name”: “Name”,
          “prompt”: “Enter user name”,
          “inputType”: “text”,
          “variable”: “userName”
        },
        {
          “type”: “openResponse”,
          “name”: “PhoneNumber”,
          “prompt”: “Enter phone number”,
          “inputType”: “phone”,
          “variable”: “userPhoneNumber”
        },
        {
          “type”: “openResponse”,
          “name”: “Last4OfSSN”,
          “prompt”: “Enter last 4 digits of SSN”,
          “inputType”: “number”,
          ”variable”: “userLast4SSN”
        },
        {
          “type”: “openResponse”,
          “name”: “PIN”,
          “inputType”: “number”,
          “prompt”: “Enter account PIN”,
          “variable”: “userPin”
        }
      ],
      “next”: “module-5”
    },
    {
      “id”: “module-5”,
      “type”: “choiceYesNo”,
      “name”: “offerResetLink”,
      “prompt”: “Would you like me to send you a link for resetting your password?”,
      “next”: { “1”: “module-6”, “2”: “module-12” }
    },
    {
      “id”: “module-6”,
      “type”: “webhook”,
      “name”: “getResetLink”,
      “url”: “https://nicepasswordreset.free.beeceptor.com/api/rest/genPasswordResetLink”,
      “method”: “POST”,
      “request”: [
        { “key”: “user”, “variable”: “userName” },
        { “key”: “last4SSN”, “variable”: “userLast4SSN” },
        { “key”: “phone”, “variable”: “userPhoneNumber” },
        { “key”: “pin”, “variable”: “userPin” }
      ],
      “response”: [
        { “key”: “passwordResetLink”, “variable”: “resetLink” },
        { “key”: “email”, “variable”: “userEmail”, “type”: “email” }
      ],
      “next”: “module-7”
    },
    {
      “id”: “module-7”,
      “type”: “email”,
      “name”: “sendResetLink”,
      “to”: “<userEmail>”,
      “subject”: “Password reset link for you”,
      “body”: “Hi,\n\nPlease use the following link to reset your password:\n\n<resetLink>\n\nThanks.”,
      “next”: “module-13”
    },
    {
      “id”: “module-13”,
      “type”: “notify”,
      “name”: “emailSent”,
      “prompt”: “I've sent a password reset link to your email address. Please use the link to create a new
password!”,
      “next”: “module-8”
    },
    {
      “id”: “module-8”,
      “type”: “choiceYesNo”,
      “name”: “confirmLinkWorked”,
      “prompt”: “Were you able to use the link?”,
      “next”: { “1”: “module-11”, “2”: “module-12” }
    },
    {
      “id”: “module-11”,
      “type”: “choiceYesNo”,
      “name”: “linkWorkedAcknowledge”,
      “prompt”: “Okay, we're all set. Are you able to login now?”,
      “next”: { “1”: “module-10”, “2”: “module-12” }
    },
    {
      “id”: “module-12”,
      “type”: “notify”,
      “name”: “resetPassword”,
      “prompt”: “I understand. Let me reset it for you now.”,
      “next”: “module-11”
},
{
      “id”: “module-10”,
      “type”: “notify”,
      “name”: “closing”,
      “prompt”: “It's always our pleasure to help. Thank You!”
    }
  ]
}
```

The output response generated in response to the training provided above with the various modules can be the following, where the task is completely different, i.e., “collecting feedback from users about a board meeting.” But the training example of resetting a password still teaches the system to generate this entirely different workflow using the proper modules in the proper sequence:

```
{
  “campaignName”: “Collect Feedback from Users about a Board Meeting”,
  “logo”: “https://upload.wikimedia.org/wikipedia/commons/thumb/2/2a/Nice_Logo_2.svg/498px-
Nice_Logo_2.svg.png”,
  “activate”: false,
  “modules”: [
    {
      “id”: “module-1”,
      “type”: “onbrowser”,
      “name”: “launchIapp”,
      “next”: “module-2”
    },
    {
      “id”: “module-2”,
      “type”: “choiceYesNo”,
      “name”: “intentConfirmation”,
      “prompt”: “Would you like to provide feedback about the board meeting?”,
      “next”: { “1”: “module-3”, “2”: “module-10” }
    },
    {
      “id”: “module-3”,
      “type”: “notify”,
      “name”: “intentAcknowledgement”,
      “prompt”: “Great! Please provide your feedback below.”,
      “next”: “module-4”
    },
    {
      “id”: “module-4”,
      “type”: “form”,
      “name”: “collectFeedback”,
      “formInputs”: [
        {
          “type”: “openResponse”,
          “name”: “Feedback”,
          “prompt”: “Please provide your feedback about the board meeting.”,
          “inputType”: “text”,
          “variable”: “userFeedback”
        }
      ],
      “next”: “module-5”
    },
    {
      “id”: “module-5”,
      “type”: “notify”,
      “name”: “feedbackReceived”,
      “prompt”: “Thank you for your feedback!”,
      “next”: “module-10”
    },
    {
        “id”: “module-10”,
      “type”: “notify”,
            “name”: “closing”,
      “prompt”: “Thank you for your time!”,
      “next”: null
    }
  ]
}
```

Though in the above JSON examples, the enterprise persona is shown to be generating the workflows, the same capability of generating workflows can be given to the end-users by giving them the appropriate visual interfaces.

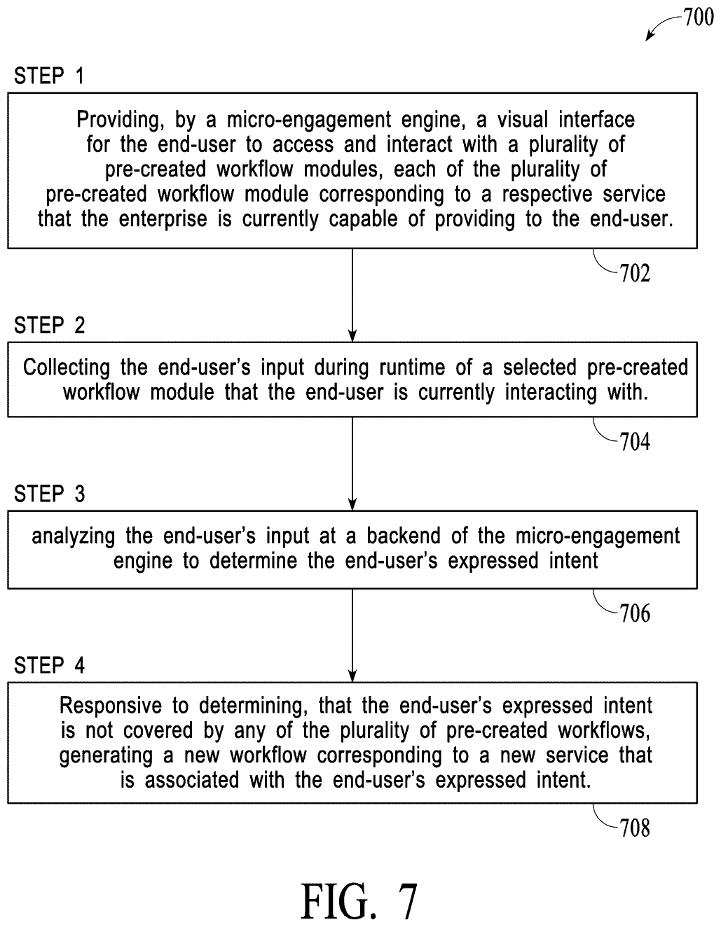

FIG. 7 is a flow diagram of an example method 700 for integrating workflows dynamically generated by an end-user during an automated interactive engagement session between the end-user and an enterprise. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by a processor coupled to the micro-engagement engine 205 of FIG. 2. Some operations or part thereof may be performed by the workflow generator 311 shown in FIG. 3 (similar to generative flow builder 209 in FIG. 2). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Specifically, at operation 702, an enterprise persona, using a micro-engagement engine, provides a visual interface for the end-user to access and interact with a plurality of pre-created workflow modules, each of the plurality of pre-created workflow modules corresponding to a respective service that the enterprise is currently capable of providing to the end-user.

At operation 704, the micro-engagement engine collects the end-user's input during runtime of a selected pre-created workflow module that the end-user is currently interacting with.

At operation 706, the end-user's input is analyzed at a backend of the micro-engagement engine to determine the end-user's expressed intent.

At operation 708, responsive to determining, that the end-user's expressed intent is not covered by any of the plurality of pre-created workflows, a new workflow is generated corresponding to a new service that is associated with the end-user's expressed intent.

FIG. 8 illustrates an example machine of a computer system 800 within which a set of instructions, for causing the machine to perform any one or more of the methodologies discussed herein, can be executed. In some embodiments, the computer system 800 can correspond to a host system that includes, is coupled to, or utilizes a memory sub-system or can be used to perform the operations of a processor (e.g., to execute an operating system to perform operations corresponding to automated workflow generation). Note that the automated workflow generation component 813 may have sub-components, for example, flow builder, natural language processor, intelligent document processor etc. to implement the multi-layer architecture shown in FIGS. 2-6. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 808 (e.g., flash memory, static random access memory (SRAM), etc.), and a data storage system 818, which communicate with each other via a bus 830.

Processing device 802 represents one or more processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 828 for performing the operations and steps discussed herein. The computer system 800 can further include a network interface device 608 to communicate over the network 820.

The data storage system 618 can include a machine-readable storage medium 824 (also known as a computer-readable medium) on which is stored one or more sets of instructions 828 or software embodying any one or more of the methodologies or functions described herein. The instructions 828 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to a memory sub-system.

In one embodiment, the instructions 828 include instructions to implement functionality corresponding to the automated workflow generation component 813. While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method for integrating workflows dynamically generated by an end-user during an automated interactive engagement session between the end-user and an enterprise, the method comprising:
providing, by an enterprise persona, using a micro-engagement engine, a visual interface for the end-user to access and interact with a plurality of pre-created workflow modules, each of the plurality of pre-created workflow modules corresponding to a respective service that the enterprise is currently capable of providing to the end-user;
collecting the end-user's input during runtime of a selected pre-created workflow module that the end-user is currently interacting with;
analyzing the end-user's input at a backend of the micro-engagement engine to determine the end-user's expressed intent; and
responsive to determining, that the end-user's expressed intent is not covered by any of the plurality of pre-created workflows, generating a new workflow corresponding to a new service that is associated with the end-user's expressed intent.

2. The method of claim 1, further comprising:
determining, by the enterprise persona, whether the new workflow is associated with a useful service that the enterprise wants to provide future end-users of the enterprise.

3. The method of claim 2, wherein the enterprise persona is a real person or a virtual person.

4. The method of claim 2, further comprising:
responsive to determining that the new workflow is associated with a useful service, storing the new workflow as an additional workflow module to be added to the plurality of pre-created workflow modules.

5. The method of claim 4, further comprising:
passing on the stored workflow to a scheduler module.

6. The method of claim 5, further comprising:
determining, by the scheduler module, an appropriate time to deploy the new workflow.

7. The method of claim 4, further comprising:
further training a large language model (LLM) with the new workflow, wherein the LLM is already pre-trained with the pre-created workflows.

8. The method of claim 5, wherein the LLM is fine-tuned with industry-specific data.

9. The method of claim 8, wherein the LLM is fine-tuned with task-specific data.

10. The method of claim 9, wherein the fine-tuned LLM receives one or more of the following as inputs: workflow variables, contextual information about communication channel, previous conversation history, and guidelines.

11. The method of claim 10, wherein LLM generates a JSON representation of the new workflow.

12. The method of claim 2, further comprising:
responsive to determining that the new workflow is not associated with a useful service, rejecting the new workflow from being added to the plurality of pre-created workflow modules.

13. The method of claim 1, wherein the micro-engagement engine uses a conversational agent to collect the end-user's input.

14. The method of claim 13, wherein a Language Intelligence Services Architecture (LISA) analyzes the end-user's input collected by the conversational agent.

15. The method of claim 1, wherein the micro-engagement engine uses a Document Intelligence Services Architecture (DISA) to analyze the end-user's input collected from a document provided or a form filled by the end-user.

16. The method of claim 1, wherein a generative flow builder module creates prompts intelligently to collect a series of responses from the end-user as the end-user's input.

17. The method of claim 1, wherein the micro-engagement engine supports interaction with the end-user via a plurality of communication channels.

18. The method of claim 17, wherein the communication channels include: short messaging service (SMS), email, web browser, voice call, data call and chat.
